(19) United States
(12) Patent Application Publication
(10) Pub. No.: US 2026/0009631 A1
(43) Pub. Date: Jan. 8, 2026

(54) POSITION SENSOR ASSEMBLY WITH CURVED WAVEGUIDE SHEATH TUBE

(71) Applicant: Temposonics Gmbh & Co. KG, Lüdenscheld (DE)

(72) Inventors: Christian Klüppel, Neuenrade (DE); Dominik Hesse, Hagen (DE)

(21) Appl. No.: 19/259,418

(22) Filed: Jul. 3, 2025

(30) Foreign Application Priority Data
Jul. 4, 2024 (DE) 202024103680

(51) Int. Cl. G01B 7/00; H01P 1/02; H01P 1/30

(52) U.S. Cl. CPC G01B 7/003; H01P 1/02; H01P 1/30

(57) ABSTRACT

A magnetostrictive position sensor assembly of a hydraulic or machine system, comprises a waveguide sheath tube having a flexible design. A waveguide is axially arranged in the waveguide sheath tube and a magnet is axially displaceable on the waveguide sheath tube.

### CROSS-REFERENCE TO RELATED APPLICATION

The present application is based on and claims the benefit of German patent application Serial No. 202024103680.8, filed Jul. 4, 2024, the content of which is hereby incorporated by reference in its entirety.

### BACKGROUND

The discussion below is merely provided for general background information and is not intended to be used as an aid in determining the scope of the claimed subject matter.

The invention relates to a position sensor assembly of a hydraulic or machine system, which comprises at least one position sensor of the magnetostrictive type, in which the position sensor detects the position of a magnet which is axially displaceable on a waveguide sheath tube with respect to a waveguide axially arranged in the waveguide sheath tube. The invention also relates to a delivery unit of such a position sensor assembly and to a hydraulic or machine system in which such a position sensor assembly is installed.

A typical sensor assembly based on the principle considered here is shown in FIG. 1. The sensors are often used in hydraulic cylinders to measure the stroke of the piston in the cylinder.

The position sensor assembly 1 consists of an electronic housing 2 and a sensor tube 3
hereinafter referred to as the waveguide sheath tube—in which the measuring section (essentially a waveguide) is located. A position magnet 4 is moved on the sensor tube, which surrounds the sensor tube. The position of the magnet along the axial extent of the sensor tube is determined by means of the magnetostrictive measuring principle.

In FIG. 1, this position magnet 4 is fastened, for example, in a piston on which the piston rod 5 is located. The magnetostrictive sensor is installed in a fixed position and with a pressure-tight seal in the associated cylinder head of a hydraulic cylinder 6. As the piston moves within the cylinder, the position of the position magnet will also shift relative to the cylinder head, and the displacement of the piston in the cylinder can be determined from the new position of the magnet.

Such sensors are now successfully used in a wide range of application areas, in particular in hydraulic systems of very different types and sizes.

For certain applications there is scope for improvement in the design of the position sensor assembly. This is true in particular for hydraulic systems with a very large piston stroke. Since the rod (the waveguide sheath tube) of the sensor is rigid, installation of the sensor requires space behind the cylinder that is at least as large as the measurement length. This space is necessary to allow the sensor to be inserted with its rigid measuring rod into the cylinder during installation and removed from it during disassembly. Disassembly may be necessary when the sensor is replaced.

A suitable box is required to transport such a sensor. While sensors with a measuring length of up to about 1 m can be transported in a cardboard box, sensors with a larger measuring length require a wooden box or similar. The longer the sensor is, the more expensive the packaging and transport of the sensor will be.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in deter-mining the scope of the claimed subject matter. The claimed subject matter is not limited to implementations that solve any or all disadvantages noted in the Background.

A magnetostrictive position sensor assembly of a hydraulic or machine system, comprises a waveguide sheath tube having a flexible design. A waveguide is axially arranged in the waveguide sheath tube and a magnet is axially displaceable on the waveguide sheath tube.

In the case of the magnetostrictive position sensor according to the invention with a flexible sensor tube or waveguide sheath tube, this does not consist of a rigid tube, but of a hose. This hose is flexible (able to bend), so that the measuring rod can be laid in an arc or even wound into a coil.

In advantageous embodiments of the invention, which allow installation in a confined space and a particularly compact packaging, it is provided that the waveguide sheath tube has a flexible design with a bending radius of less than 250 mm, in particular of less than 100 mm.

In one embodiment, the waveguide sheath tube has an elastically flexible design, but it can also be flexible in a plastic manner.

In a further practically significant embodiment, it is provided that the waveguide sheath tube has a flexible metallic shielding, which in particular can comprise a flexible metal braid in the manner of the shielding of a coaxial cable, or a plurality of metal segments movably inserted into one another in the manner of a shower hose.

In a further embodiment of the invention, the waveguide sheath tube has a fluid-tight outer sheath, in particular made of or containing polytetrafluoroethylene, e.g. Teflon® or a polyurethane.

In embodiments of the invention which allow a significant extension of the application range, the waveguide sheath tube has a length of more than 8,000 mm, up to 20 m or more.

In further advantageous embodiments of the invention it is provided that the flexible waveguide sheath tube has an outer diameter of 8 mm or less, in particular of 6.5 mm or less. This allows insertion into existing rigid sensor tubes of well-known measuring arrangements.

In one embodiment of the invention, the position sensor assembly is provided with a sensor electronics housing directly attached to the waveguide sheath tube.

A proposed delivery unit is configured with a packaging box in which the waveguide sheath tube is received in a bent condition, such that all dimensions of the packaging box are smaller than the length of the waveguide sheath tube. This allows easy logistical handling of assemblies with very long waveguide sheath tubes.

One design of this proposed delivery unit is such that the waveguide sheath tube is accommodated in the packaging box in coiled form, in particular in multiple coils.

At least in practical embodiments of the invention, it delivers one or more of the following advantages:
The sensor can be wound up when being transported, so that little space is needed.
The sensor can be installed in confined spaces because it can be inserted into a guide in curved form.
The sensor can be implemented with large measuring lengths-sensors with an inflexible or rigid measuring rod are most commonly supplied with a measuring length of up to about 8 m. The sensor electronics of the magnetostrictive position sensor with flexible measuring rod is designed in such a way that measuring lengths of 20 m and more can be implemented with suitable current pulse generation.
In combination with the sensor electronics housing, the flexible sensor tube complies with safety class IP68 and achieves electromagnetic compatibility by means of its metallic coating.

### BRIEF DESCRIPTION OF THE DRAWINGS

Advantages and convenient features of the invention also arise from the following description of exemplary embodiments and from the drawings. These show:

FIG. 1 a schematic perspective view of a conventional position sensor assembly;

FIG. 2 a schematic sectional view of an embodiment of the position sensor assembly; and

FIG. 3 a perspective view of the position sensor assembly according to FIG. 2 with coiled waveguide sheath tube.

### DETAILED DESCRIPTION OF ILLUSTRATIVE EMBODIMENTS

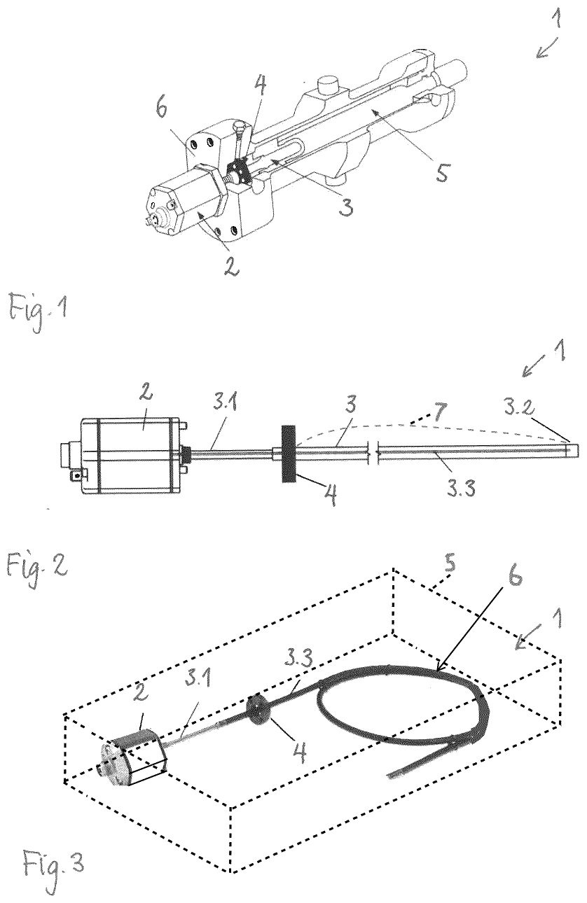

FIG. 2 shows an embodiment of the position sensor assembly 1 wherein the essential parts are designated with the same numerals as in FIG. 1. It is also shown that the sensor tube (waveguide sheath) 3—which is shown here as straight, but is in fact flexible—has a connecting piece 3.1 for connection to the electronic housing 2 and at the other end an end piece 3.2, and that the sensor element (the waveguide) 3.3 is arranged in the latter.

FIG. 3 shows this embodiment with a coiled waveguide sheath tube 3.

Like the rigid tube in the case of a rod-shaped sensor, the hose assembly protects the internal sensor element 3.3 from the environment. In addition, the flexible hose offers a supporting action to prevent excessively small bending radii which would cause damage to the sensor element. The connecting element 3.1 at the junction between the sensor electronics housing 2 and the flexible hose 3 ensures that the sensor element is not torn off from the sensor electronics housing 2 by bending.

The flexible sheath tube of the sensor assembly is designed by way of example in such a way that it can be inserted into a hydraulic assembly of a position sensor in rod form. The sensor electronics housing 2 of the magnetostrictive position sensor with flexible sensor rod or waveguide sheath tube 3 is mounted in this case on the flange of the hydraulic assembly. This means that the sensor with its flexible measuring rod can be used in the same way as a magnetostrictive position sensor in rod form.

A proposed delivery unit is configured with a packaging box 5 in which the waveguide sheath tube 3 is received in a bent condition, such that all dimensions of the packaging box 5 are smaller than the length of the waveguide sheath tube 3. This allows easy logistical handling of assemblies with very long waveguide sheath tubes.

One design of this proposed delivery unit is such that the waveguide sheath tube 3 is accommodated in the packaging box 5 in coiled form, in particular in multiple coils 6.

On the other hand, the flexible waveguide sheath tube 3 enables not only a novel, compact packaging and thus corresponding delivery unit of the position sensor assembly, but also the operation of the magnetostrictive position sensor in hydraulic or machine systems in which the movable element, the position of which is to be determined, moves along a curved path (shown schematically in FIG. 2 at 7), e.g. during adjustment of the blade angle of a turbine. In these use cases, the waveguide sheath tube 3 is routed such that is corresponds to the movement path of the part in question. It goes without saying that the position magnet 4 must be designed in such a way that together with the movable part it can glide smoothly along the curved waveguide sheath tube. Optionally, the electronics module can also be adapted to suit such a configuration.

Moreover, the invention can also be embodied in a plurality of variations of the examples shown here and aspects of the invention highlighted above.

Although the present invention has been described with reference to preferred embodiments, workers skilled in the art will recognize that changes may be made in form and detail without departing from the spirit and scope of the invention.

What is claimed is:

1. A magnetostrictive position sensor assembly for a hydraulic or machine system, comprising:
a waveguide sheath tube having a flexible design;
a waveguide axially arranged in the waveguide sheath tube; and
a magnet axially displaceable on the waveguide sheath tube.

2. The magnetostrictive position sensor assembly according to claim 1, wherein the waveguide sheath tube has an elastically flexible design.

3. The magnetostrictive position sensor assembly according to claim 1, wherein the flexible design of the waveguide sheath tube has a bending radius of less than 250 mm.

4. The magnetostrictive position sensor assembly according to claim 3, wherein the waveguide sheath tube has an elastically flexible design.

5. The magnetostrictive position sensor assembly according to claim 1, wherein the flexible design of the waveguide sheath tube has a bending radius of less than 100 mm.

6. The magnetostrictive position sensor assembly according to claim 5, wherein the waveguide sheath tube has an elastically flexible design.

7. The magnetostrictive position sensor assembly according to claim 1, wherein the waveguide sheath tube has a flexible metallic shielding.

8. The magnetostrictive position sensor assembly according to claim 1, wherein the waveguide sheath comprises a flexible metal braid or a plurality of metal segments that can be movably inserted into one another.

9. The magnetostrictive position sensor assembly according to claim 1, wherein the waveguide sheath comprises a plurality of metal segments movably inserted into one another.

10. The magnetostrictive position sensor assembly according to claim 1, wherein the waveguide sheath tube has a fluid-tight outer sheath.

11. The magnetostrictive position sensor assembly according to claim 1, wherein the waveguide sheath is made of or contains polytetrafluoroethylene or a polyurethane.

12. The magnetostrictive position sensor assembly according to claim 1, wherein the waveguide sheath tube has a length of more than 8,000 mm.

13. The magnetostrictive position sensor assembly according to claim 1, wherein the waveguide sheath tube has an outer diameter of 8 mm or less.

14. The magnetostrictive position sensor assembly according to claim 1, wherein the waveguide sheath tube has an outer diameter of 6.5 mm or less.

15. The magnetostrictive position sensor assembly according to claim 1 and further comprising a sensor electronics housing attached to the waveguide sheath tube.

16. The magnetostrictive position sensor assembly according to claim 1 and further comprising a packaging box in which the waveguide sheath tube is received in a bent condition, such that all dimensions of the packaging box are smaller than a length of the waveguide sheath tube.

17. The magnetostrictive position sensor assembly according to claim 16 wherein the waveguide sheath tube is accommodated in the packaging box in a coiled form.

18. The magnetostrictive position sensor assembly according to claim 17 wherein the waveguide sheath tube is accommodated in the packaging box with multiple coils in the coiled form.

19. A hydraulic or machine system having a position sensor assembly according to claim 1 for detecting the position of a hydraulic piston in a hydraulic cylinder or of a movable machine part within the machine, wherein a motion path of the hydraulic piston or the movable machine part is curved and the waveguide sheath tube of the position sensor assembly has a curvature corresponding to the motion path in an operating state.
